(19) United States
(12) Patent Application Publication
(10) Pub. No.: US 2003/0152745 A1
(43) Pub. Date: Aug. 14, 2003

(54) Profile composite component and method for the production thereof

(76) Inventor: Joachim Wagenblast, Hong Kong (CN)

Correspondence Address: BAYER POLYMERS LLC, 100 BAYER ROAD, PITTSBURGH, PA, 15205, US

(21) Appl. No.: 10/275,456

(22) PCT Filed: Apr. 25, 2001
(86) PCT No.: PCT/EP01/04632

(51) Int. Cl. B32B 3/04

(52) U.S. Cl. 428/119; 428/122

(57) ABSTRACT

A composite structural part consisting of two or more sections (1) and (2) and a process for producing same, in which at least one section (1) with a free end is abutted with or inserted into the second section (2), characterised in that reinforcement elements (3, 3′; 6, 6′; 23; 25; 21) which form a positive fit with sections (1) and (2) are fixed in the region of the connection point (10) for sections (1) and (2) and that sections (1) and (2) are connected by injecting or shrinking a thermoplastic plastics material in the region of the connection point (10).

The invention provides a composite structural part consisting of two or more sections and a process for producing same in which at least one section with a free end is abutted with or inserted into the second section, characterised in that reinforcement elements which form a positive fit with the sections are fixed in the region of the connecting point of the sections and that the sections are bonded to each other by injecting or shrinking a thermoplastic plastics material in the region of the connection point.

The invention provides in particular a process for joining sections and sheets by creating very strong and very rigid composite structural parts, in particular using plastics/metal hybrid modes of construction, wherein joining the semi-finished product and producing the composite structural part is achieved simultaneously by thermoforming thermoplastic moulding compositions.

The invention also provides a process for connecting semi-finished products by creating a junction region which can be subjected to high stresses using a hybrid mode of construction.

The process produces composite structural parts which consist of very strong and very rigid components, such as e.g. steel or composite materials, which are joined, held in position and also supported in shape by ribs or solid walls using a thermoplastic plastics material.

Very strong connections for supports, sections, sheets etc. which are subject to high stresses are often present in the construction of vehicles or machines. In this case, supports made of steel or aluminium are largely used, these being welded or bonded to each other in the junction region. For further stiffening of the connection points, also called junction points in the following, braces are integrated or cast junctions, e.g. Al diecasting, are used. Another possibility is the use of semi-finished products made of composite materials (plastics reinforced with long-fibres). These are generally bonded to each other by lamination with junction elements which also consist of composite materials.

These modes of operation which are conventionally used in practice have the disadvantage that the joining processes are time-consuming and enable only limited dimensional accuracy and reproducibility during mass production. If braces are used for additional stiffening of the junction elements, these have to be specified with thick walls (1 to 3 mm) in order to prevent failure due to buckling or bending. Conventional wall thicknesses for metal sheeting used in the automobile industry are 0.7 to 1.2 mm when manufacturing private cars. This increases the weight of components, which is in conflict with efforts made by constructors in particular in the vehicle construction sector.

Thus, the invention is based on the object of creating joining processes with junction points of the type mentioned at the beginning which facilitate the very strong and very rigid bonding of supports and sheets and also enable economically viable joining of semi-finished products and structural part components to form structural components. In addition, the manufacture of composite structural parts should take place with the dimensions being largely retained and with high reproducibility. A particular object is to avoid the failure of thin-walled sections with a wall thickness of 0.5 to 1 mm due to the injection pressure when processing sections in injection moulding machines.

This object is achieved, according to the invention, in that parts made of very strong materials are used to connect the semi-finished products or structural part components and to stiffen the composite structural parts, these being arranged in a positive fit in the junction region. Then the junction region is provided with a thermoplastic component which holds together all the individual parts and prevents premature buckling or bending of the very strong individual parts in the junction region.

The invention provides a composite structural part consisting of two or more sections in which at least one section with a free end is abutted with or inserted into the second section, characterised in that reinforcement elements which form a positive fit with the sections are fixed in the region of the connection point of the sections and that the sections are bonded to each other by injecting or shrinking thermoplastic plastics in the region of the connection point.

The reinforcement elements are e.g. sheets or diecast parts made of very strong materials. The very strong materials may be steel, aluminium, magnesium, ceramics, thermoset materials or long fibre-reinforced plastics, composites or plastics which are reinforced with industrial textiles.

The thermoplastics plastics material may consist of a non-reinforced or reinforced or filled plastics material e.g. based on polyamide (PA), polyester, in particular polyethylene terephthalate (PET), polybutylene terephthalate (PBT), polyolefin, in particular polypropylene (PP), polyethylene (PE), a styrene/acrylonitrile copolymer, in particular an acrylonitrile/styrene/butadiene copolymer (ABS), polycarbonate (PC), polypropylene oxide (PPO), (PSO), polyphenylene sulfide (PPS), polyimide (PI), (PEEK), polyketone syndiotactic polystyrene (PS) or of any possible mixture of these plastics.

Sections in the context of the invention are, for example, open or sealed sections made of plastics or metal (preferably metal, e.g. steel, aluminium, magnesium) with any cross-section at all. Sealed sections with round or rectangular cross-sections or open U-sections are preferred. The sections preferably have a wall thickness of 0.3 to 1.5 mm, particularly preferably 0.5 to 1.2 mm.

The reinforcement elements, as very strongly bonding components, are used in the form of e.g. clamps, rings and half-shells which are fitted to the shape of the sections (semi-finished products) and structural part components and are also held together for support, in particular using braces and/or preferably with further support sheeting. They are placed round the sections and other structural part components to be joined. The reinforcement elements are used to reinforce and stiffen the connection point and are shaped so that they form a positive fit with the semi-finished products and structural part components to be joined.

In a preferred form of the composite structural part, the reinforcement elements are provided with additional support walls which also prevent bending of the connection point in particular in the case of abutting sections.

A composite structural part in which a one-piece reinforcement element is provided at the connection point of the sections, into which the sections are pushed or inserted before being injected with the thermoplastic plastics material, is particularly preferred.

The thermoplastic component is arranged as a connection material using a thermoforming process in such a way that it holds in position structural parts (sections and sheets), which abut each other in a positive manner, but are otherwise loosely connected with the aid of the reinforcement elements, and the reinforcement elements themselves. This may take place by partial or complete encapsulation of the reinforcement elements.

The transfer of force from one structural part to another thus takes place via the very strong components in the reinforcement elements. An additional increase in the strength of the composite structural part is achieved by optional additionally moulded ribs or by filling up the cavities (which are formed e.g. by individual support sheets) with the thermoplastic component, because buckling or bending of the braces and support walls in the reinforcement elements then takes place only under high loads.

A composite structural part has proven to be particularly advantageous in which openings or drilled holes are provided in the sections and/or in the reinforcement elements at overlapping places, through which the thermoplastic plastics material can pass and to which the thermoplastic plastics material is anchored.

In addition, or as an alternative, in another preferred variant of the composite structural part, deformations, in particular indentations or bulges, may be provided in the sections and/or in the reinforcement elements at overlapping places, to which the thermoplastic plastics material is anchored.

A preferred composite structural part in which the reinforcement elements are designed in one piece with at least one of the sections, and in which the sections form a positive fit with each other, is particularly advantageous.

For example, for this purpose the interlocking sections may be shaped in such a way that they have matching tongue/groove combinations or projections which ensure the formation of a positive fit.

One section may also have, in the region of the connecting point, a reinforcement in the shape of materials preferred for the reinforcement elements or a thicker wall.

Furthermore, a process has been found for connecting sections (semi-finished products or structural part components) by producing a composite structural part during the joining process which is constructed from at least two different materials. One material component consists of a thermoplastic material while the other component is generally manufactured from a very strong material.

The invention therefore also provides a process for producing a composite structural part according to the invention, characterised in that two or more sections are inserted or pushed into reinforcement elements or are clamped by reinforcement elements, with the formation of a temporary connecting point, and then the connecting point is entirely or partly encapsulated by a thermoplastic plastics material in an injection moulding mould, wherein the sections are bonded with the reinforcement elements.

A process in which open sections are used and reinforcement struts are produced in the open sections when injecting with the thermoplastic plastics material are preferred.

In a particularly preferred process, to improve the rigidity of open sections, additional reinforcement struts are produced in the region of the connecting point when injecting with the thermoplastic plastics material.

An alternative method of production for producing a composite structural part according to the invention is characterised in that two or more sections are inserted or pushed into reinforcement elements or are clamped by reinforcement elements, with the formation of a temporary connecting point, and then the connecting point is entirely or partly surrounded with one or more moulded pieces made of shrinkable thermoplastic plastics material and the sections are then bonded to the reinforcement elements by heat treatment of the moulded pieces.

A particularly preferred process is characterised in that deformations are provided in the sections and/or the reinforcement elements, in particular indentations or bulges, and/or openings or drilled holes at specific places in the sections and/or the reinforcement elements, before assembling or inserting, so that these overlap each other when assembling or inserting the sections and/or reinforcement elements before applying the thermoplastic plastics material.

Since the joining process is achieved via a thermal shaping procedure for the thermoplastic component, contraction of the thermoplastic plastics material can be used to build up stresses which ensure permanent and strong connection in the region of the connecting point for the sections.

In addition, further additional elements are integrated in the composite structural part which fulfil mechanical functions such as e.g. supporting additional sheets or supports, fixing in place subsequently mounted parts or accepting further structural parts. These integral elements may be produced on the one hand by the insertion of further positive fitting elements made of very strong materials and on the other hand by producing shapes for indentations, recesses or screw-domes using the thermoplastic component.

Producing the composite structural part and thus also performing the joining process may take place in various ways. The possible processes differ primarily in application of the thermoplastic component:

Joining by Means of Injection Moulding:

In joining process using injection moulding, the structural part components to be joined (sections or sections and sheets and the reinforcement elements) are first placed in an injection moulding mould. Then the injection moulding mould is closed and the thermoplastic plastics material is injected. Since the plastics material is introduced to the injection moulding mould in liquid form, the parts laid therein can be surrounded on all sides and this secures the positive fit already achieved by the shape of the reinforcement elements. By means of openings in the semi-finished products and structural part components and/or reinforcement elements being joined, gating of the thermoplastic component in the form of rivet heads, in particular in the region of the overlapping openings in the sections and reinforcement elements, can also be achieved. If this type of gating takes place, complete encapsulation of the junction region is not required.

In order to prevent molten plastics material penetrating the interior of sections when joining, for example, hollow sections, these are permanently sealed on the front face with a cover (e.g. with welding sheeting or with sheeting-reinforced plastic caps) or temporarily sealed by using moveable cores mounted in the mould. When applying high injection pressures in the injection moulding process, the collapse of hollow sections is similarly prevented by inserting moveable cores in the injection moulding mould or by inserting permanent rib structures, double-T-pieces or other reinforcements, e.g. made of expanded metal, in the hollow section.

Joining by Shrinkage of Thermoplastic Elements:

The procedure in this process variant does not basically differ from the previous method using injection moulding. Here again, the semi-finished products and structural part components and reinforcement elements to be joined are assembled in a positive fit manner, but in loose association. Then, however, the assembly of these individual parts is secured with a connecting element consisting of a thermoplastic plastics material which extends over or snaps onto the junction in the junction region. The thermoplastic connecting element used has previously been stretched and is now shrunk to build up frictional support for the reinforcement elements joined in a positive fit by heating the semi-finished product or the structural part components and reinforcement elements in the junction region.

Combination of Different Joining or Thermoforming Processes:

Further possibilities for joining semi-finished products or structural part components and reinforcement elements consist of combining the two processes described above.

In addition, it may also be advantageous first of all to put in place clamps, shells, etc. made of thermoplastic materials with and without reinforcements (e.g. inserted sheeting) and then finally to complete the connecting elements surrounding every side of the junction region by using injection moulding, adhesion or welding.

Furthermore, production of the reinforcement elements and manufacture of the connecting element and the joining process may be combined in one process step. If, for example, the reinforcement elements consist of metal sheeting, this may be provided with its final shape during the injection moulding process. For this purpose, sheeting which is flat or already shaped to a certain extent is laid in the injection mould along with the structural parts to be joined. By bringing together the two halves of the mould and applying the requisite closing force, the reinforcement sheeting is shaped so that it lies round the structural parts and is given the shape of the structural parts. Then connection of the structural parts and the reinforcement elements to be joined is achieved by injection and cooling of the molten plastics material.

The advantages produced by the invention can be summarised as follows:

The invention enables the formation of permanent, very strong and very rigid junctions and composite structural parts by using simply shaped semi-finished products.

The simultaneous joining of several connection points is possible within one injection moulding mould.

The production process incorporates a high degree of retention of dimensions and reproducibility when mass producing structural parts with connection points.

The integration of additional mechanical or other functions in naturally very strong and very rigid junction regions is enabled.

The design of composite structural parts can be optimised with regard to cost and weight.

The invention also provides the use of composite structural parts according to the invention in an appropriate design as structural elements for machines, vehicles and structural parts of all kinds, in particular for motor vehicles, for electronic items, domestic appliances and for building materials.

Particularly suitable applications for the composite structural parts are structural parts for motor vehicles, in particular doors, bumpers, brackets, front and rear parts for private cars, door sill support frames, instrument panel supports, tailgate supports, roof frames and decorative elements which combine increased strength with other materials properties.

The invention is explained in more detail in the following, using figures, without thereby restricting the invention in detail.

These show:

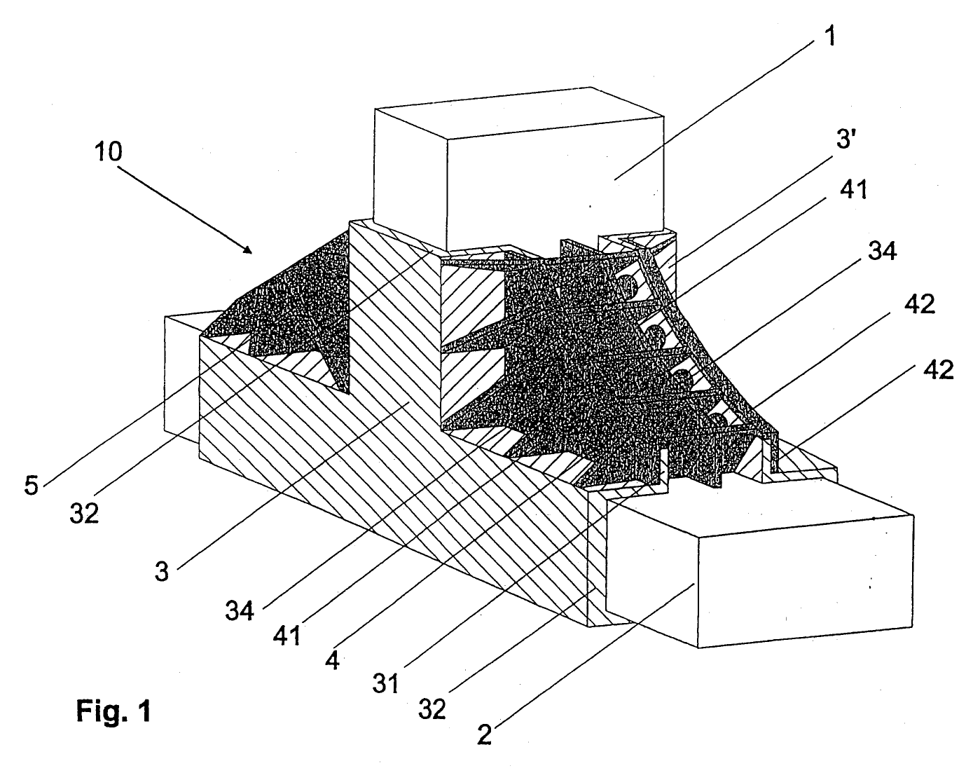

FIG. 1 a composite structural part with two reinforcement elements 3, 3′ for connecting two rectangular sections connected by an injected thermoplastic material

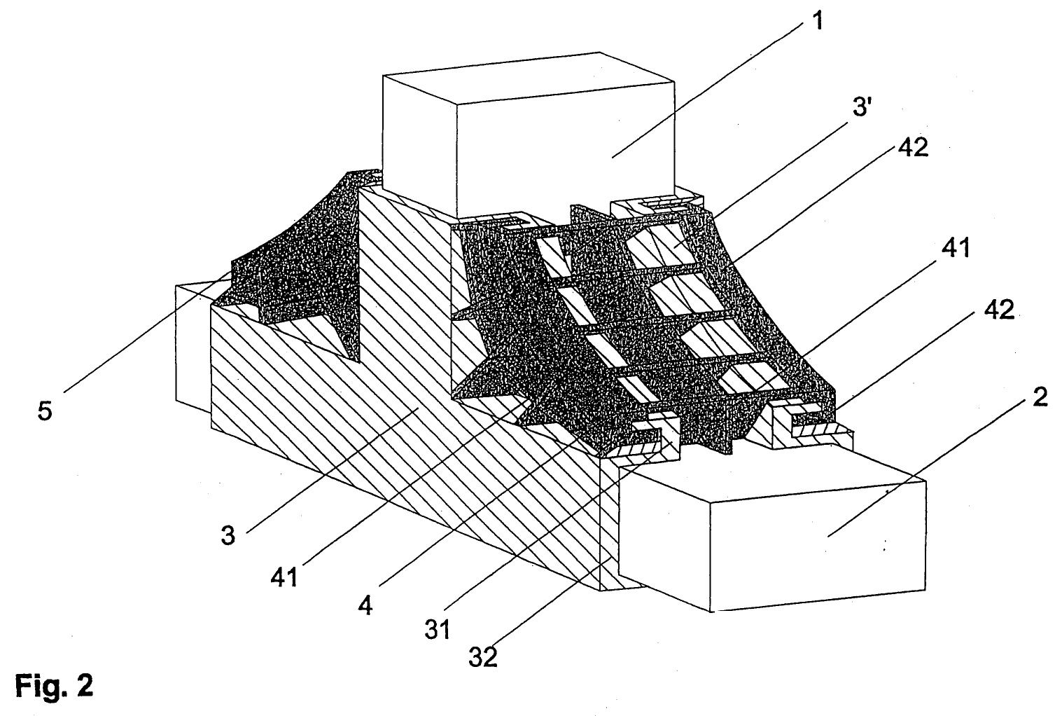

FIG. 2 a composite structural part similar to FIG. 1 with an additional reinforcement edge

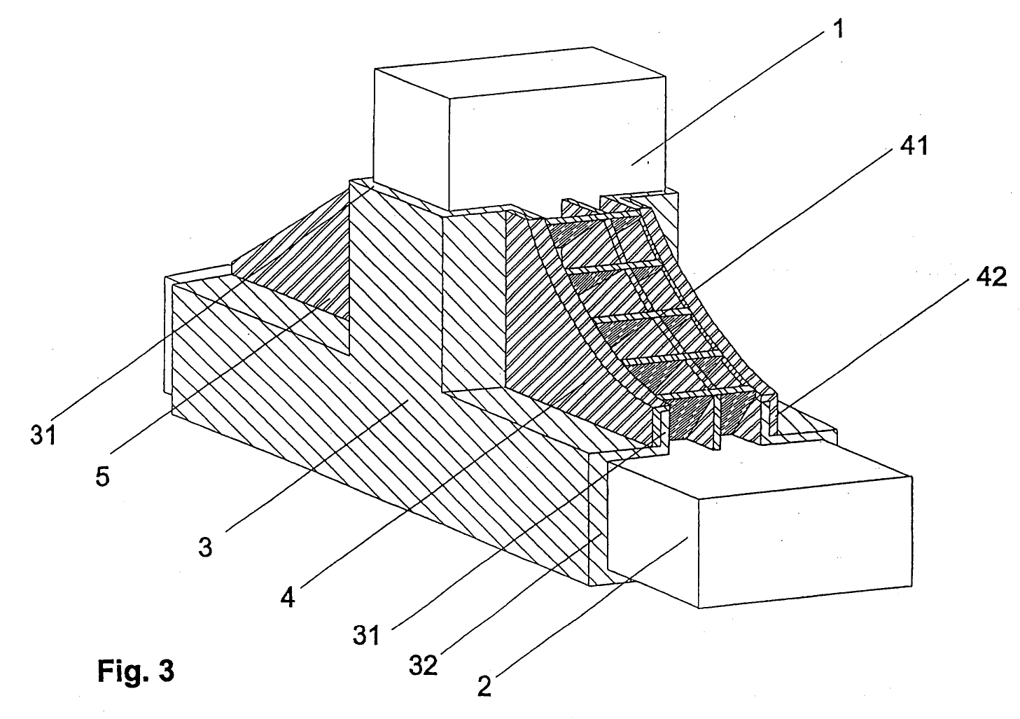

FIG. 3 a composite structural part similar to FIG. 1 with a connection formed by shrunk thermoplastic moulded parts 4, 5

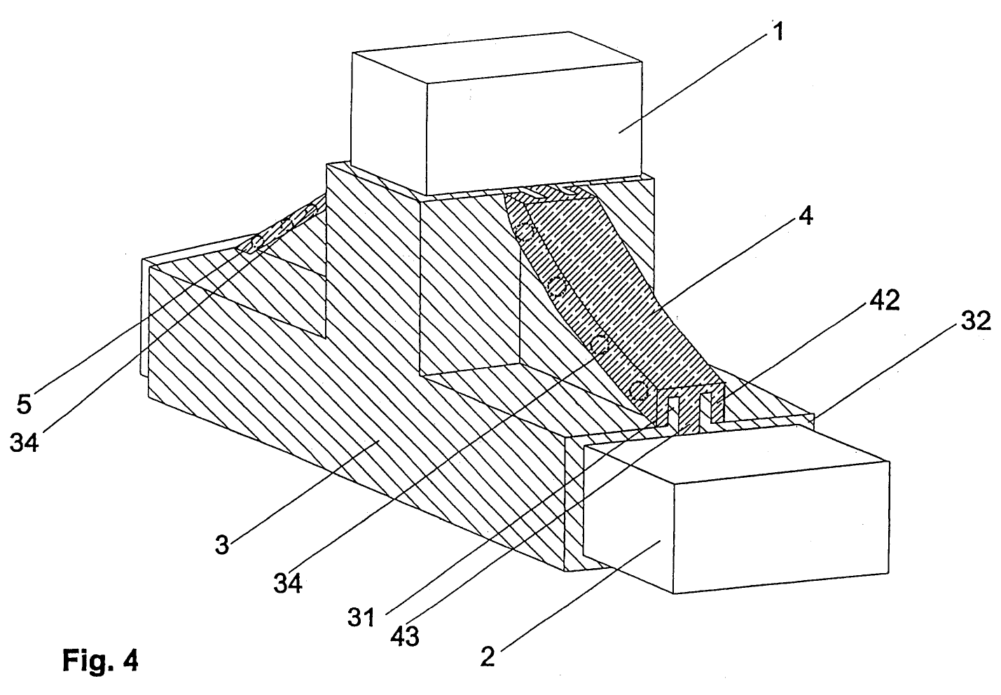

FIG. 4 a composite structural part similar to FIG. 1 but without lateral rib structures made of thermoplastic material and with one-piece reinforcement element 3

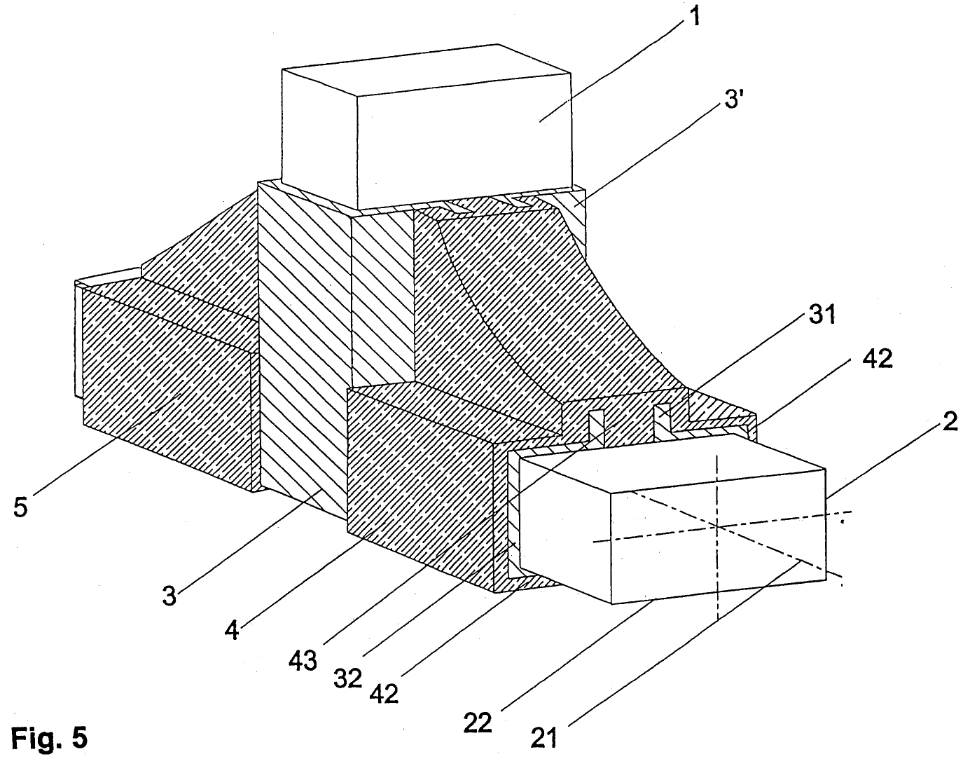

FIG. 5 a composite structural part similar to FIG. 1 with fully encapsulated reinforcement elements 3, 3′

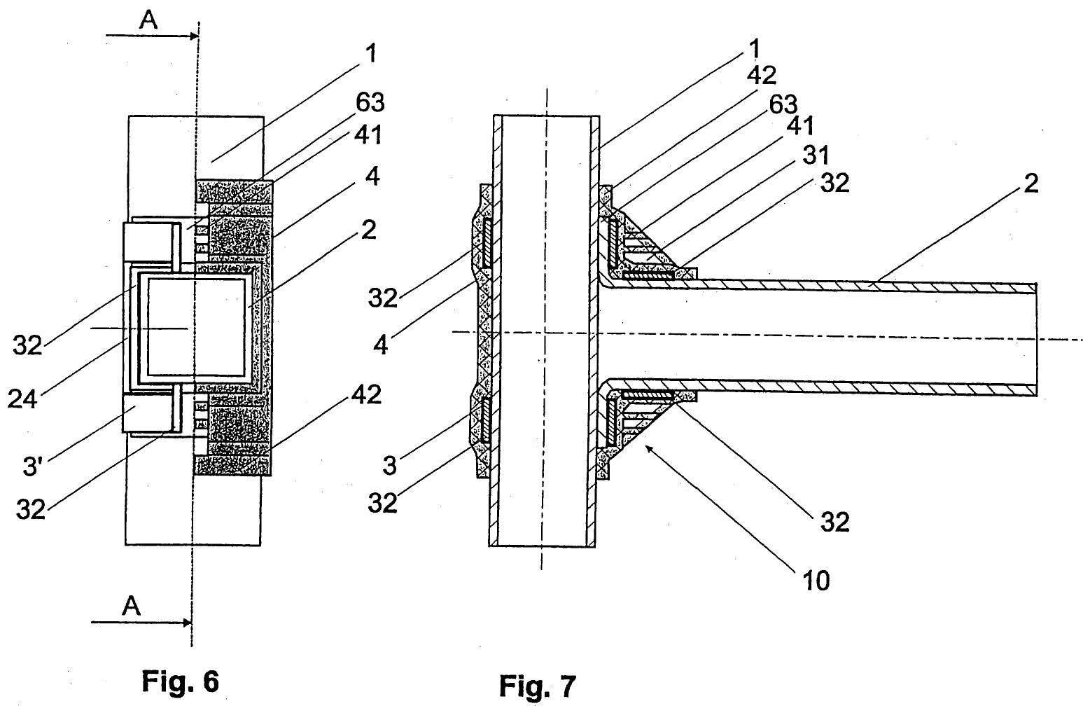

FIG. 6 view from the side of a composite structural part with two reinforcement elements 3, 3′ with a flange 63 at the end of section 2 and a connection point 10 fully encapsulated with a plastics material

FIG. 7 cross-section through a composite structural part as shown in FIG. 6 taken along the line A-A in FIG. 6

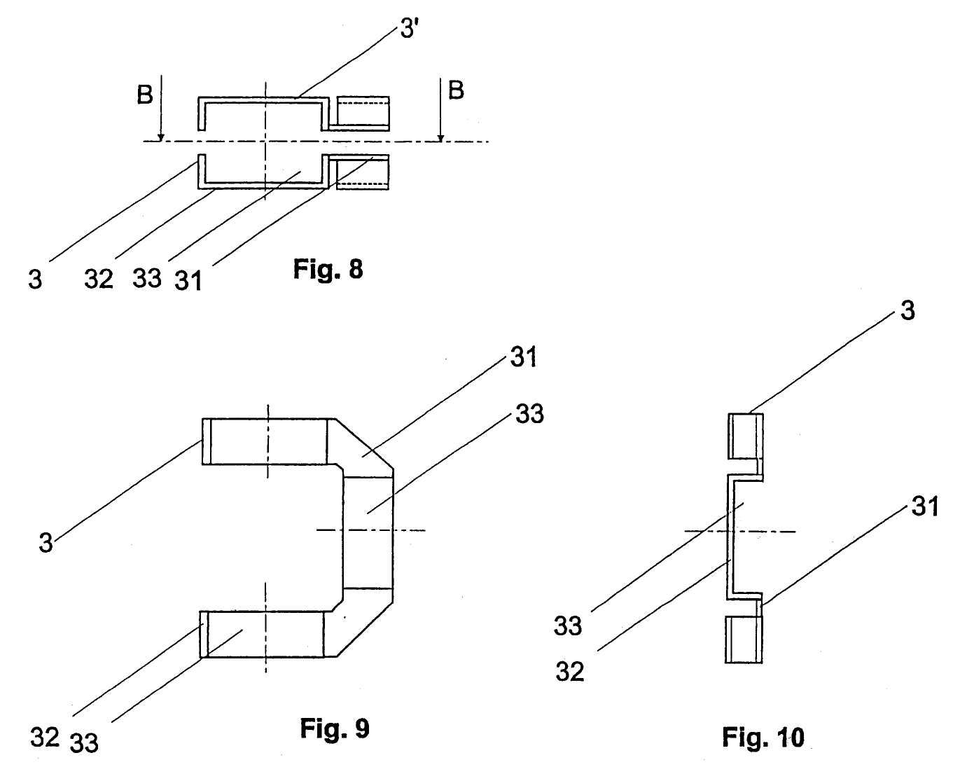

FIG. 8 individual representation of reinforcement elements 3, 3′ for a composite structural part as shown in FIG. 6

FIG. 9 view of reinforcement elements 3, 3′ as shown in FIG. 8

FIG. 10 side view of reinforcement elements 3, 3′ as shown in FIG. 8

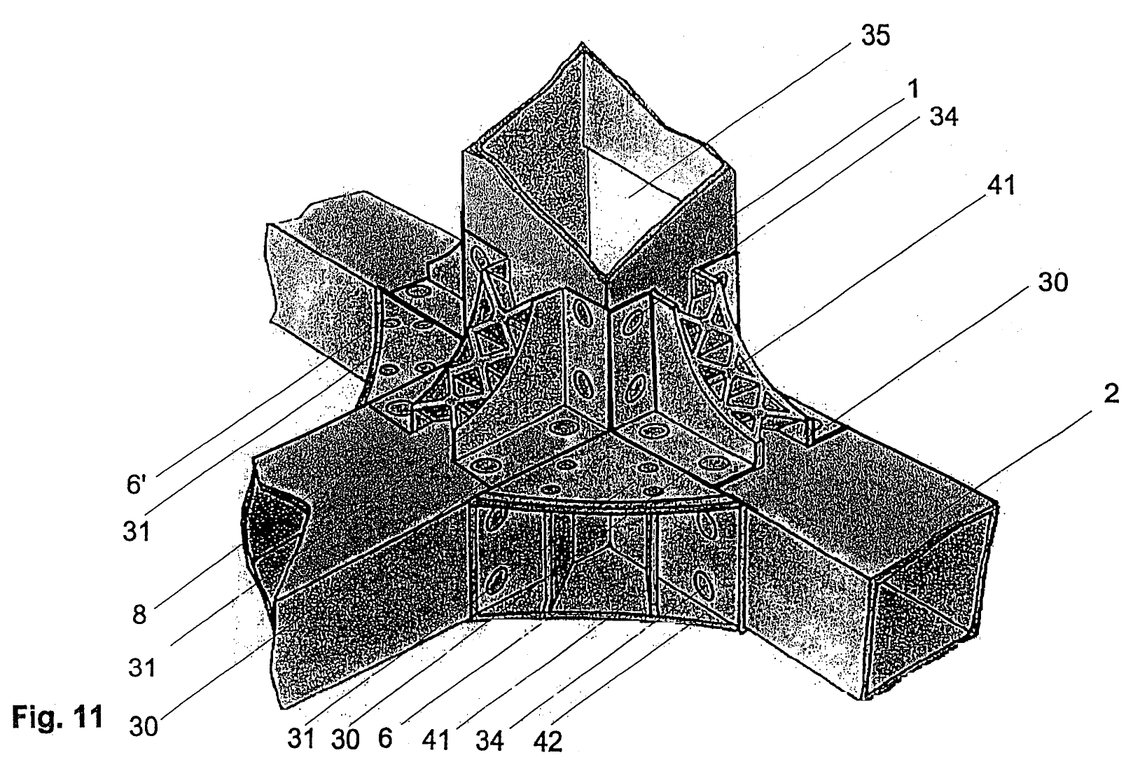

FIG. 11 a composite structural part made from three sections 1, 2, 8 in which sections 1 and 8 abut section 2

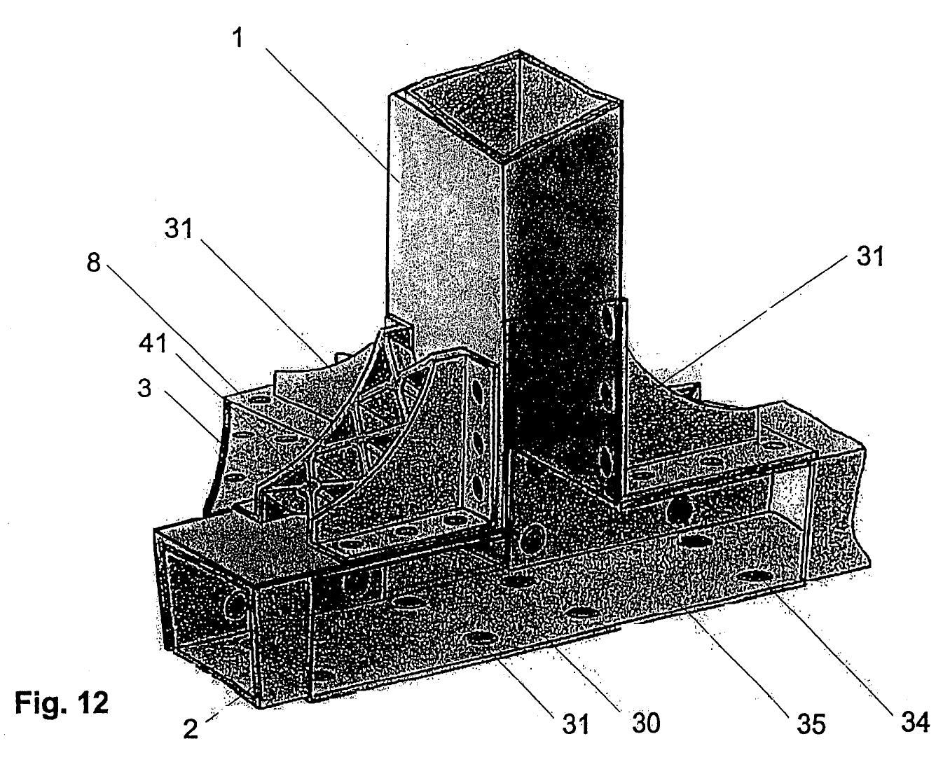

FIG. 12 a composite structural part as shown in FIG. 11, seen from the rear

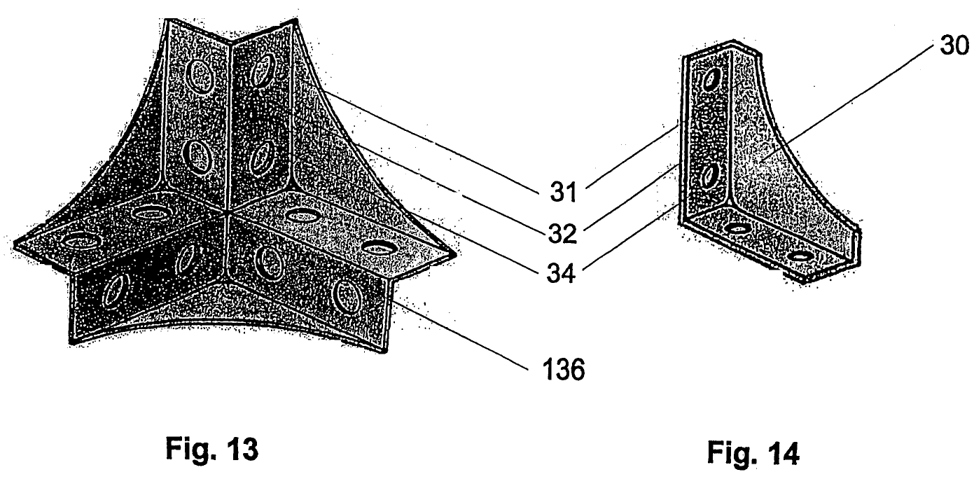

FIGS. 13, 14 different shaped reinforcement elements 30, 136 for the composite structural part shown in FIG. 11

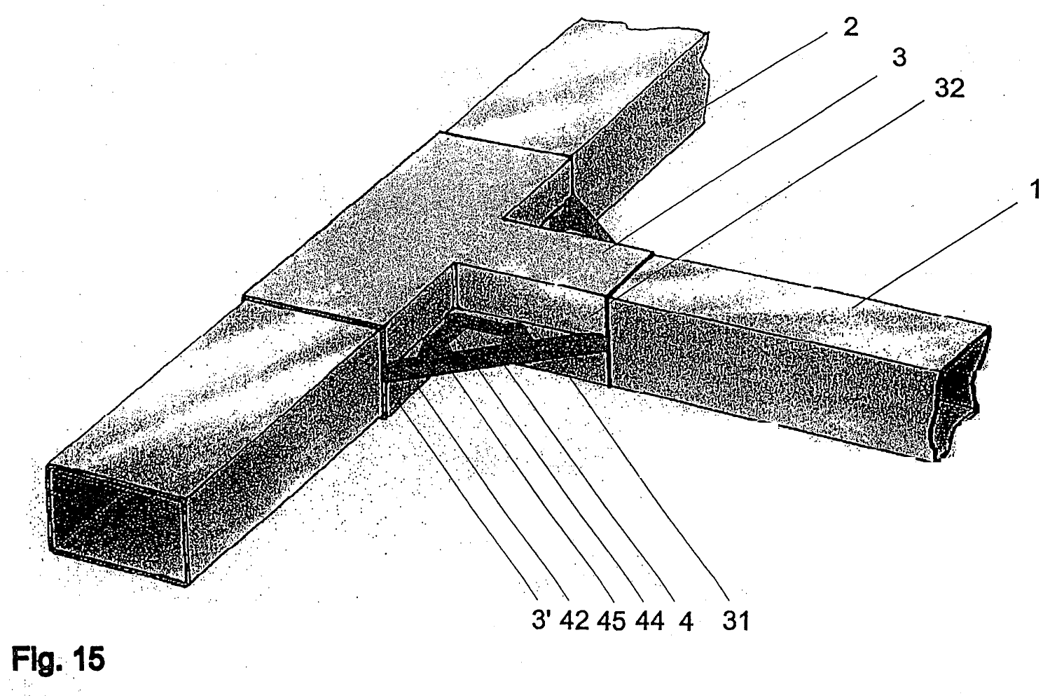

FIG. 15 a composite structural part made of thin-walled hollow sections 1, 2 similar to FIG. 4 but with two reinforcement elements 3, 3′

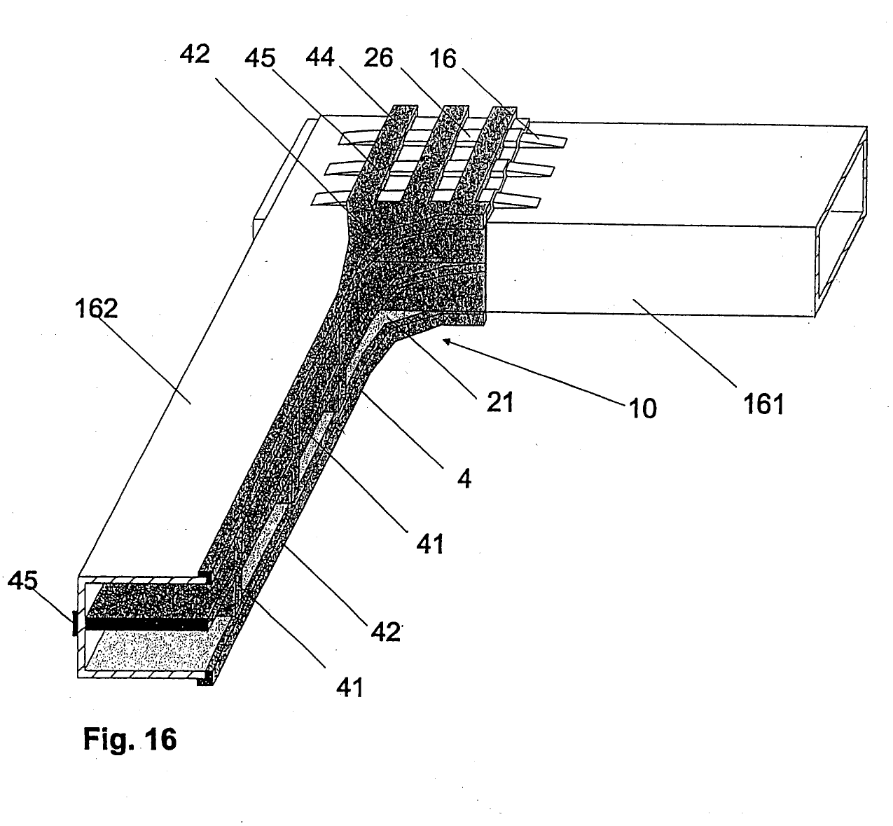

FIG. 16 a composite structural part made from a box-section 161 and a U-section 162 with reinforcement elements 21, 23, 25 integrated in the U-section

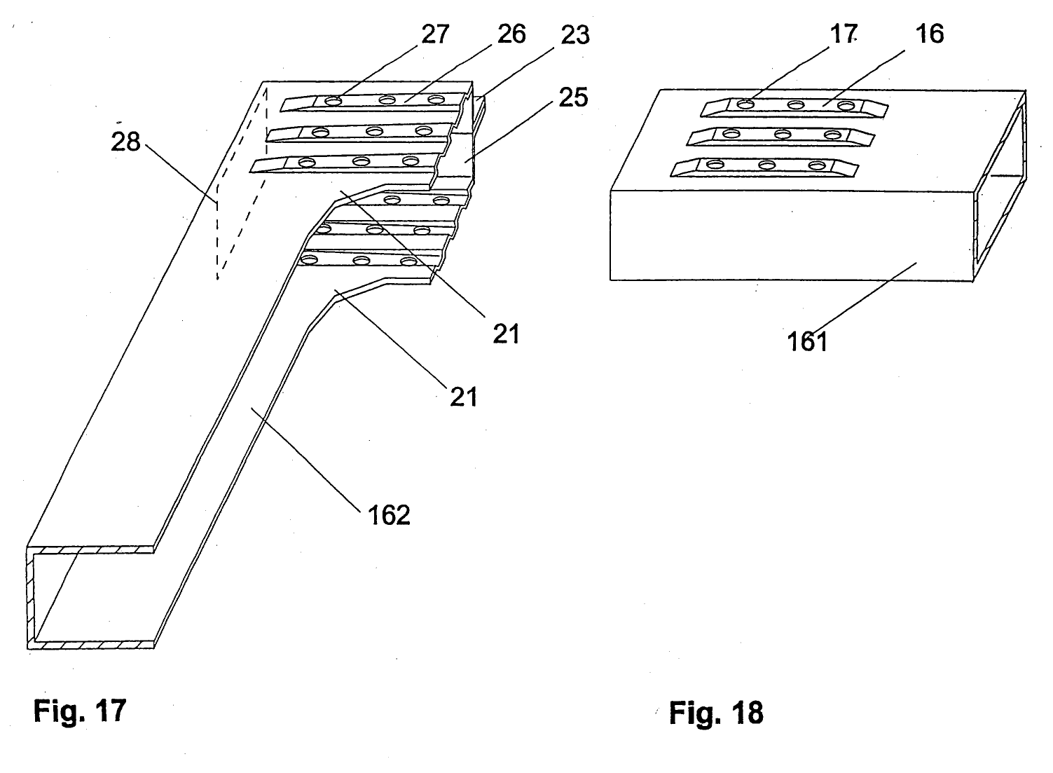

FIG. 17 individual representation of the U-section in FIG. 16

FIG. 18 individual representation of the box-section in FIG. 16

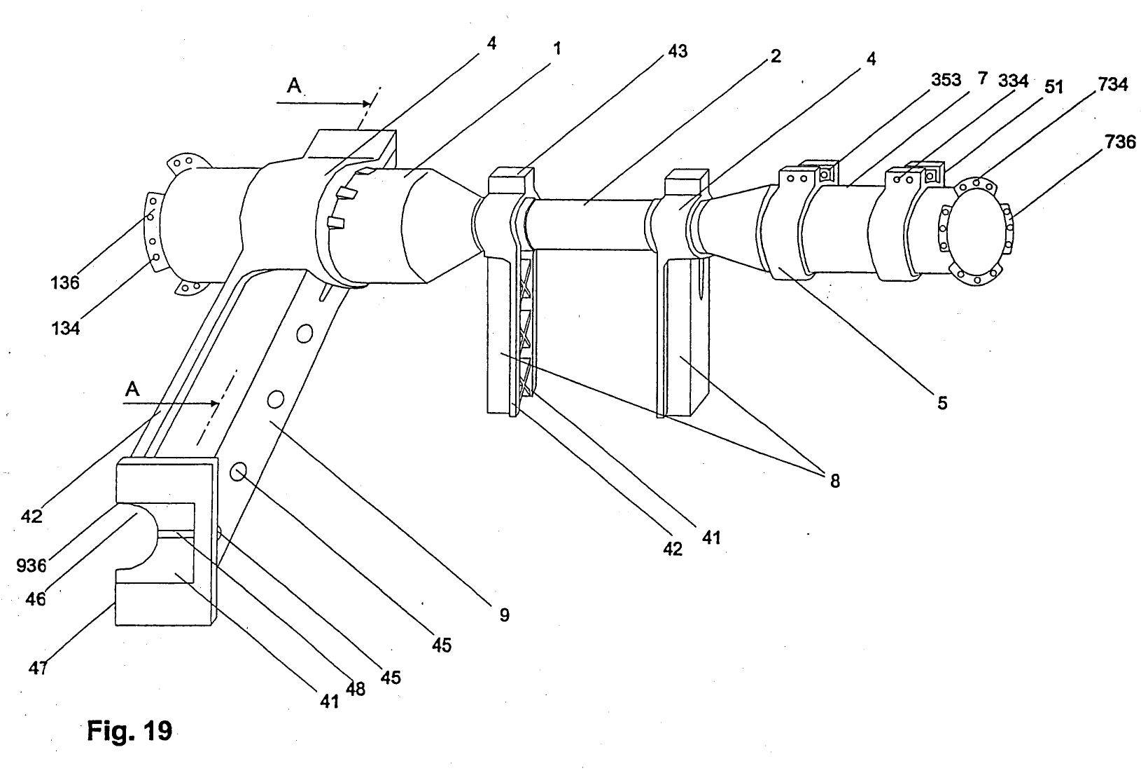

FIG. 19 a transverse support for a motor vehicle instrument panel as an example of a complex composite structural part

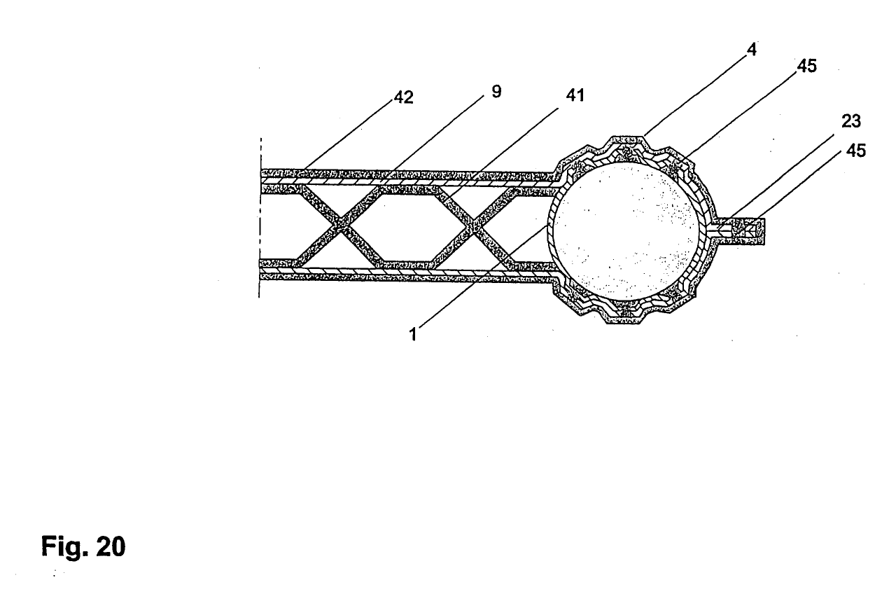

FIG. 20 longitudinal section through section 9 of the transverse support in FIG. 19 taken along line A-A in FIG. 19

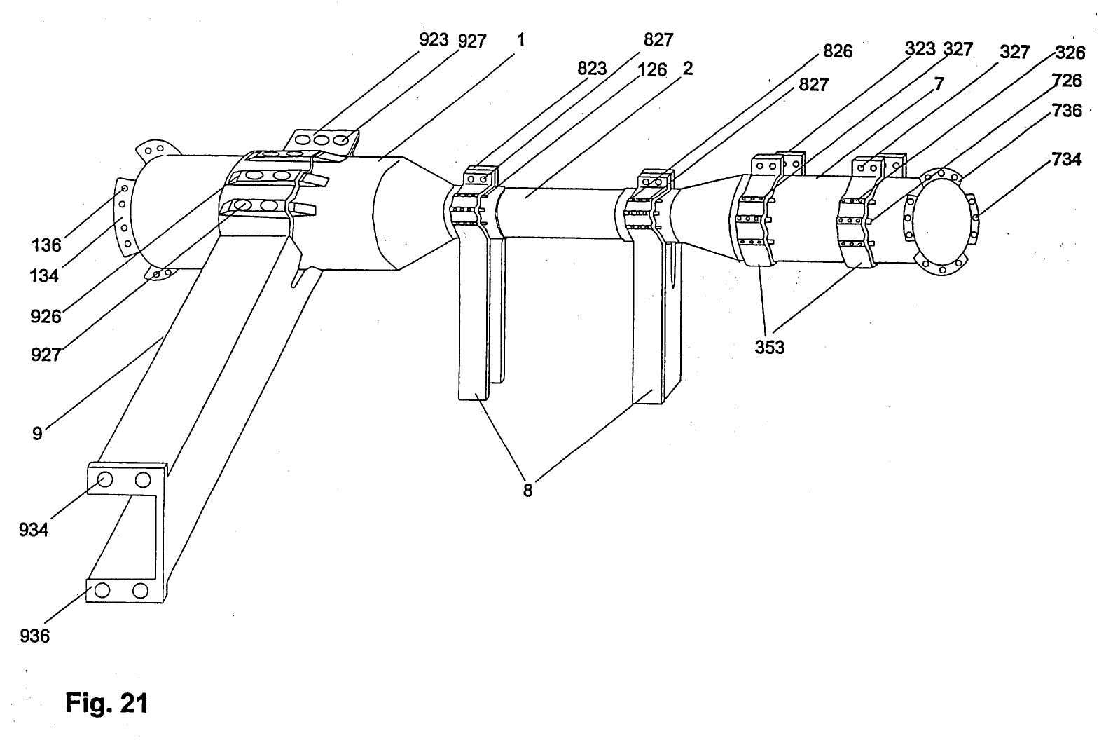

FIG. 21 view of transverse support in FIG. 19 without the injected plastics material surrounding the section

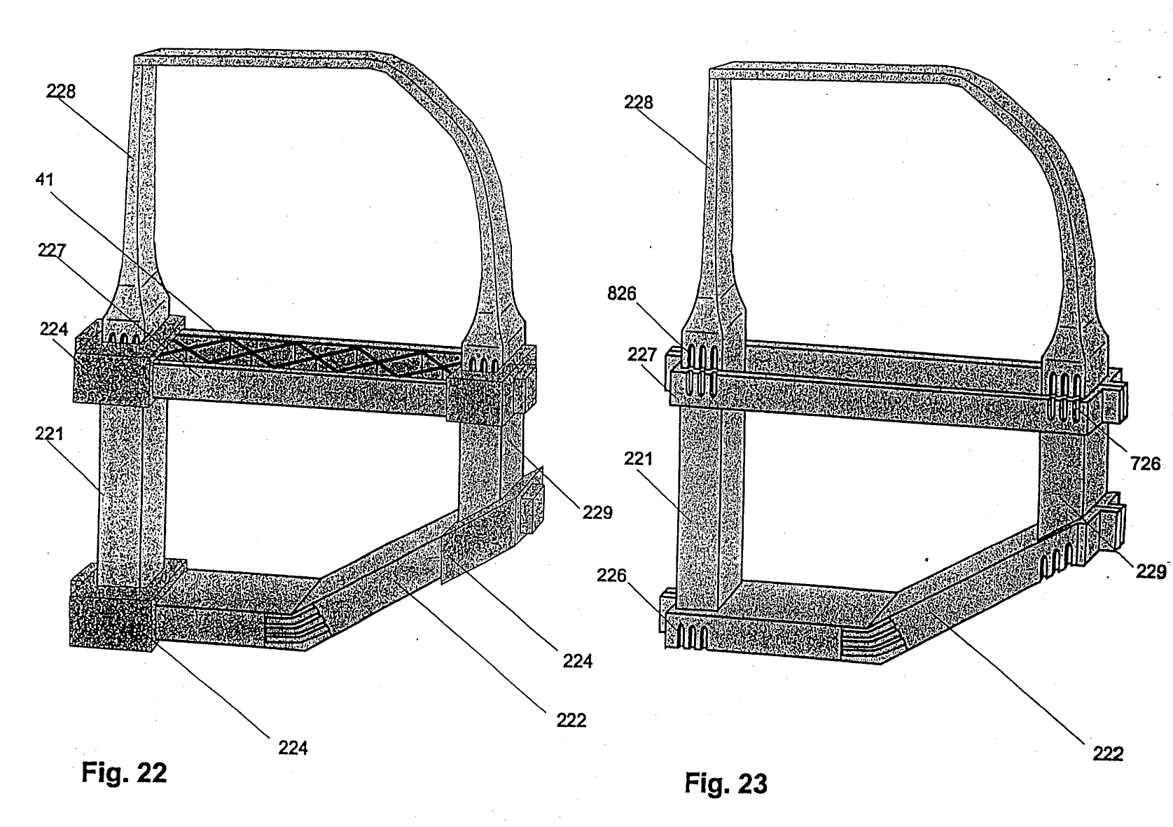

FIG. 22 door frame structure for a motor vehicle as another example of a complex composite structural part

FIG. 23 view of the door frame structure without the injected plastics material surrounding the sections

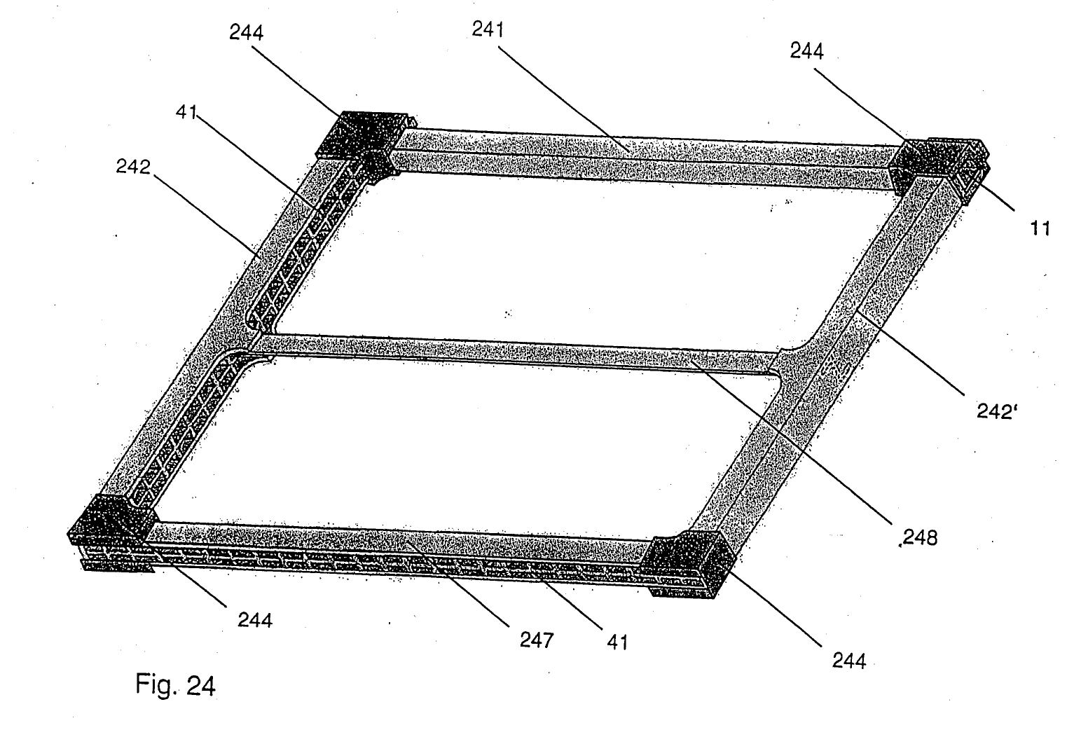

FIG. 24 tailgate frame for a motor vehicle as another example of a complex composite structural part

### EXAMPLES

Connecting Bar-Shaped Solid and/or Thick-Walled Hollow Sections: FIGS. 1 to 10

### Example 1

The composite structural parts shown in FIGS. 1 to 5 involve the connection of two rectangular bar-shaped structural parts (sections) 1 and 2 which are held together positively via very strong and very rigid reinforcement elements 3 and 3′ and are firmly connected and supported by means of connection pieces 4 and 5 made of a thermoplastic plastics material. In FIGS. 6 and 7, the structural parts to be joined and reinforcement elements are held together and supported by means of a thermoplastic plastics material 4 which surrounds connection point 10.

In all the diagrams in FIGS. 1 to 10, sections 1 and 2 are held in position with respect to each other by support walls 31 integrated in reinforcement elements 3, 3′. This prevents lateral movement of section 1 against section 2. The contour of sections 1 and 2 is enclosed by wall 32 of reinforcement elements 3 and 3′. This produces a positive fit between the sections 1 and 2 to be joined and reinforcement elements 3, 3′.

If thin-walled hollow sections are joined by means of injection moulding, care must be taken to ensure that failure or collapse does not take place due to the relatively high injection pressure when injecting the molten plastics materials into the injection moulding mould. In order to prevent this, there are basically two types of solution. On the one hand, the hollow sections can be supported internally using cores and, on the other hand, there is the possibility of limiting the effect of the injection pressure on the reinforcement elements by the structural design of the composite structural part.

FIG. 1 shows a composite structural part with two reinforcement elements 3, 3′ for connecting two rectangular sections 1, 2 which are connected to each other by an injected thermoplastic material 4.

FIG. 2 shows a similar composite structural part to that in FIG. 1 in which the reinforcement elements are provided with an additional reinforcement edge in the region of the support wall.

In the composite structural part in FIG. 4, reinforcement element 3 is in one piece.

In the composite structural part shown in FIGS. 1 to 3, the sections 1 and 2 to be joined are pushed into or inserted into reinforcement elements 3, 3′ and placed in an injection moulding mould. Connection elements 4 and 5 are produced by injecting thermoplastic component 4 which holds together reinforcement elements 3, 3′ via the simultaneously produced walls 42 and rib structure 41 made of thermoplastic plastics material.

In the case of a composite structural part as shown in FIG. 3, connection elements 4 and 5 may also be premoulded separately. These are then stretched prior to the joining process and then placed on support walls 31. As a result of subsequent heating, thermoplastic parts 4, 5 in this variant shrink tightly onto reinforcement elements 3, 3′. In the composite structural parts in FIGS. 1 to 3, the two support walls 31 which bulge slightly inwards are supported by rib structure 41. Premature buckling or bending of support walls 31 is prevented in this way.

In the composite structural parts in FIGS. 4 and 5, this task is performed by wall 43 made of thermoplastic plastics material and located between support walls 31. In the composite structural parts in FIGS. 1 and 4, thermoplastic material 4 and 5 is drawn through drilled holes 34 which are provided in reinforcement elements 3, 3′ and positively anchored to these same reinforcement elements 3, 3′ by the thermoplastic material.

In the composite structural part in FIG. 5, reinforcement elements 3, 3′ in the region of connection points 4 and 5 are encircled by walls 42 which surround them. In this case, reinforcement elements 3, 3′ are split along the longitudinal axis 21 of the lower face 22 of section 2. The mode of operation is not thereby impaired as compared with the design in FIG. 4 and assembly of the two halves of reinforcement element 3 is simplified.

The composite structural part shown in FIGS. 1 to 7 shows connections of sections with a rectangular cross-section. Since the internal contour of reinforcement elements 3, 3′ can be matched to the contour of the sections being joined, however, other cross-sectional sections can also be connected to each other. If sections with circular cross-sections are to be connected, adequate resistance to torsion can be ensured by mounting feather keys, by distorting the sections in the region of the junction to give an oval cross-section or by similar measures.

The composite structural part in FIG. 6 is formed by sections 1 and 2 and by two reinforcement elements 3 and 3′ (see also FIGS. 8 to 10) which are placed in a positive fit on two faces of the sections 1 and 2 to be joined. Then thermoplastic material 4 is injected onto sections 1 and 2 to be joined and also reinforcement elements 3, 3′ in the region of connection point 10. In FIG. 6, sections 1 and 2, positively joined together, and also reinforcement element 3′ are shown on the left-hand side of the figure. The right-hand side shows the fully formed connection in which thermoplastic material 4 has been injected onto sections 1 and 2 and reinforcement element 3. In this diagram, reinforcement element 3 is completely covered by connection thermoplastic material 4 and therefore cannot be seen.

The composite structural parts in FIGS. 6 and 7 show how section 2 is connected to section 1 via additional flanges 63 and 24. Reinforcement elements 3 and 3′ ensure high resistance to torsion via walls 32 which surround sections 1 and 2 in a form fit manner and ensure high resistance to bending between sections 1 and 2 via support walls 31. Connection thermoplastic material 4, which surrounds all the individual parts 1, 2, 3, 3′, ensures that the connection holds together due to the materials stresses built up in the thermoplastic material during the injection moulding process. Ribs 41 made of thermoplastic material mutually support the support walls 31 which bulge inwards.

Connecting Bar-Shaped Thin-Walled Hollow Sections: FIGS. 11 to 15

### Example 2

FIGS. 11 and 12 show a composite structural part which has an opening 35 in the rear face in order to facilitate the insertion of a core in the injection moulding mould and thus provide support for hollow sections 1, 2 and 8 during the injection moulding process. When producing the composite structural part, first of all structural parts 1, 2 and 8 to be joined and reinforcement elements 6, 6′ and 30 (see also FIG. 14) are laid in the injection moulding mould. Then the thermoplastic component is injected and walls 42 and rib structure 41 are formed and drilled holes 34 are filled. To increase the rigidity of the composite structural part, opening 35 may be sealed with metal sheeting after injecting the thermoplastic component.

Sections 1, 2 and 8 being connected are mutually supported by support walls 31 in reinforcement elements 6, 6′ and 30 and held together by rib structure 41, the fillings in drilled holes 34 and walls 42. The reinforcement elements 6, 6′ and 30 may be let into indentations (not shown) in structural parts 1, 2 and 8 in order to achieve additional form fitting between reinforcement elements 6, 6′ and 30 and the sections 1, 2 and 8 being joined.

Another means of reinforcing composite structural parts is illustrated in FIG. 13. A reinforcement element 136 for reinforcing a corner is shown, this corner being formed by three bar-shaped structural parts similar to those shown in FIG. 11. The sections being joined lie against walls 32 and are mutually supported by support walls 31. Due to the presence of drilled holes 34, a rivet junction can be made between the sections being joined and reinforcement element 136.

In the composite part shown in FIG. 15, a solution is shown in which the effect of the injection pressure during the injection moulding process is restricted to the region outside the hollow sections being joined. Hollow sections 1 and 2 and reinforcement elements 3, 3′ are laid in the injection moulding mould and encased with the thermoplastic component only in the region of support wall 31.

The thermoplastic component forms the connection element 4 which is produced from walls 42, connection pegs 44 and rivet heads 45. Due to the presence of connection pegs 44, the walls 42 and rivet heads 45 can be formed by the thermoplastic component via a gate in each of the two support walls 31. Rivet connection of reinforcement elements 3, 3′ is produced by superimposed drilled holes (not shown) which are located in support walls 31 of reinforcement elements 3 and 3′ in the region of rivet heads 45. The connection of reinforcement elements 3 and 3′ is additionally strengthened by edge encapsulation in the region of wall 42.

Reinforcement elements 3 and 3′ may also be let into indentations (not shown) in structural parts 1 and 2 in order to achieve additional form fitting between reinforcement elements 3 and 3′ and the sections 1 and 2 being connected.

Connecting a Thin-Walled Hollow Section to a U-Section Using an Integral Reinforcement Element: FIGS. 16 to 18

### Example 3

In the composite structural part shown in FIG. 16, hollow section 161 is connected directly to U-section 162. Both sections are manufactured from metal and are shown separately in the non-connected state in FIGS. 17 and 18. U-section 162 is designed to be lower in the connection region so that a support wall 21 can be integrated on the upper and lower faces. In this design, integral reinforcement elements are present in the section. The function of the reinforcement elements is achieved by parts 21, 23 and 25 working together. As a result of the rib structure 4 with ribs 41 and edge encapsulation 42, shown in FIG. 16, support walls 21 are held in shape under load in order to prevent premature failure due to buckling. By means of interlocking indentations 16 and 26, hollow section 161 is connected positively with U-section 162. In the region of openings 17 and 27, moulded plastic rivets 45 can be produced on connection pegs 44 in rib structure 4 and these secure connection of the two sections 161 and 162. To further improve the resistance to torsion of the composite structural part, U-section 162 is sealed on the rear face with wall 25 and flange 23. Flange 23 may also contain additional drilled holes (not shown) which are also used to form rivet connections.

When producing the composite structural part, first of all section 161 is pushed into section 162 so that section 161 lies in recess 128 (see also FIG. 17) of section 162. Then the two sections 161 and 162 are laid in an injection moulding mould. Ribs 41, edge encapsulation 42, connection pegs 44 and plastic rivets 45 are formed simultaneously when thermoplastic component 4 is injected. Connection pegs 44 ensure that the molten plastics material gains access to openings 17 and 27 (see FIGS. 17 and 18), in order to form plastic rivets 45, and also to flange 23 (see FIG. 17) during the injection moulding process. The latter leads to the production of edge encapsulation (not shown) and again to the production of optional further plastic rivets (not shown). Section 161 is supported in connection region 10 using a moveable core in the injection moulding mould, this being inserted into hollow section 161 through opening 28 in section 162, in order to prevent collapse of section 161 due to the high injection pressure during the injection moulding process.

The type of connection shown in FIG. 16 can also be achieved with a U-section turned through 180°. In addition, it is also suitable for joining sections with the following section combinations:

cylindrical hollow section to U-section

U-section to U-section

U-section to double-T-section

U-section to Z-section.

### Application Examples

Transverse Support for an Instrument Panel in a Motor Vehicle (FIGS. 19 to 20)

### Example 4

FIG. 19 shows an example of a transverse support for an instrument panel in a motor vehicle, the support consisting of tubular segments 1, 2 and 7. The transverse support is held to the wing sections, not shown, by flanges 136 and 736 via drilled holes 134 and 734 located therein. In the middle, it is supported by two U-sections 8. To fasten the steering column (not shown), U-section 9 is mounted on tubular segment 1. Section 9 is fastened to the bodywork (see FIG. 21) via flange 936 and drilled holes 934. The passenger airbag is held in place via drilled holes 334 on the two fixing elements 353, which are connected to tubular segment 7. The individual sections 1, 2, 3, 7, 8, 9 are assembled and are held together by overspraying with thermoplastic plastics material 4. In order to be able to indicate the junction regions in the connections between sections 1, 2, 3, 7, 8, 9, these are shown in FIG. 21 without the thermoplastic overspray. Sections 1, 2, 7, 8, 9 are connected positively with each other via indentations 126, 326, 726, 826 and 926. Firm connection of the individual components 1, 2, 7, 8 and 9 is performed via superimposed drilled holes 327, 827 and 927, which are filled with the thermoplastic material 4 during overspraying (see FIG. 19). These connections are achieved by rivets 45 (see FIG. 20) which are formed as integral constituents of oversprays 4 and 5. The resistance to torsion of the connections is improved by using flanges 323, 823 and 923. To make U-sections 8 and 9 more rigid, these are provided with a rib structure 41. Rib structure 41 is connected to overspray 4 in the multi-part connection region via edge encapsulation 42 and 47. Rib structure 41 is anchored to U-section 8 or 9 at rib intersections 48 via rivets 45. Recess 46 in rib structure 41 of U-section 9 is intended to take the steering column.

To produce the transverse support, first of all the individual sections 1, 2, 7, 8 and 9 are assembled. In addition, it is possible to produce tubular sections 1, 2 and 7 from one tube (by internal high-pressure thermoforming (IHT)) or from two half-shells which are split longitudinally. The assembled sections 1, 2 7, 8 and 9 are laid in an injection moulding mould. The mould is closed and a core, which is a constituent of the injection mould, is inserted into each opening in sections 1 and 7. The cores are designed so that they form an image of the internal contour of tubular segments 1, 2 and 7 in the inserted condition. Then the thermoplastic plastics material is injected and thermoplastic oversprays 4 and 5 with moulded rib structures 41 and edge encapsulations 42 and 47 are formed. The moveable mould cores, which project into tubular segments 1, 2 and 7 during the injection moulding process prevent collapse of these due to the high injection pressure.

### Example 5

Door Structure for a Commercial Vehicle (FIGS. 22 and 23)

FIG. 22 shows the connection of sections 221, 222, 227, 228 and 229 to make a door frame structure with thermoplastic oversprays 224. In FIG. 23, to explain the connection regions, only sections 221, 222, 227, 228 and 229, without the thermoplastic oversprays, are shown. Sections 221, 228 and 229 consist of torsion-resistant sealed box sections. Section 228 forms the window frame and is widened out at the lower end so that it can be form fit assembled with sections 221 and 229. In other design variants, sections 221, 228 and 229 are also welded together from individual parts or consist of one IHT part. Sections 222 and 227 are U-shaped sections which are strengthened with a thermoplastic rib structure 41. Form fitting assembly of sections 221, 222, 227, 228 and 229 is achieved via indentations 226, 726 and 826. Thermoplastic oversprays 224 hold the assembled individual parts 221, 222, 227, 228 and 229 firmly together.

To produce the door structure, sections 221 to 229 are assembled and laid in an injection moulding mould. The box sections 221 and 229 are filled with moveable mould cores in the same way as in the preceding application example and thus supported during the injection moulding process. Oversprays 224 in the connection regions and also rib structures 41 are formed by injecting the thermoplastic plastics material.

### Example 6

Support Structure Tailgate for a Motor Vehicle (FIG. 24)

The structure shown in FIG. 24 consists of a torsion-resistant box section 241, two side U-sections 242, 242′ which have been prestressed against bending and, to make the frame structure more rigid, a further U-section 247 and a Z-section 248. Sections 247 and 248 may also consist of U-sections or sealed box sections, in other design variants. U-sections 242, 242′ and 247 are strengthened with a rib structure 41. The Z-section 248 may also be provided with ribs or with functional elements for taking window glass, wiper motor, lock, etc. (not shown). Thermoplastic oversprays 244 hold the individual sections 241, 242, 242′, 247 and 248 together. They are anchored together positively using indentations (not shown), like the transverse support. Opening 11 is used to support box section 241 during the injection moulding process. Production is performed in the same way as in the preceding application examples by assembling sections 241, 242, 242′, 247 and 248 and then overspraying the connection region with thermoplastic plastics material 244.

1. A composite structural part consisting of two or more sections (1) and (2), in which at least one section (1) with a free end is abutted with or inserted into the second section (2), characterised in that reinforcement elements (3, 3′; 6, 6′; 23; 25; 21) which form a positive fit with sections (1) and (2) are fixed in the region of the connection point (10) for sections (1) and (2) and that sections (1) and (2) are connected by injecting or shrinking a thermoplastic plastics material in the region of the connection point (10).

2. A composite structural part according to claim 1, characterised in that the sections (1, 2) have a sealed, in particular round or rectangular, or an open, in particular U-shaped, cross-section.

3. A composite structural part according to claim 2, characterised in that the sections (1, 2) are sealed sections.

4. A composite structural part according to one of claims 1 to 3, characterised in that the reinforcement elements (3, 3′; 6, 6′; 23; 25; 21) consist of metal, in particular steel, aluminium or magnesium, of ceramic or of a very strong plastics material, in particular a thermoset material or a long fibre-reinforced plastics material or of a plastics material which is reinforced with industrial textiles.

5. A composite structural part according to one of claims 1 to 4, characterised in that the reinforcement elements (3, 3′; 6, 6′; 23; 25; 21) are designed as clamps, rings or half-shells.

6. A composite structural part according to one of claims 1 to 5, characterised in that the reinforcement elements (3, 3′; 6, 6′; 23; 25; 21) are provided with additional support walls (31).

7. A composite structural part according to one of claims 1 to 6, characterised in that a one-piece reinforcement element is provided at the connection point (10) into which the sections are pushed or inserted prior to injecting the thermoplastic plastics material.

8. A composite structural part according to one of claims 1 to 7, characterised in that openings (34) or drilled holes are provided in the sections (1, 2) and/or in the reinforcement elements (3, 3′; 6, 6′; 23; 25; 21) at overlapping places, through which the thermoplastic plastics material can pass and to which the thermoplastic plastics material is anchored.

9. A composite structural part according to one of claims 1 to 8, characterised in that deformations (16, 26), in particular indentations or bulges, are provided in the sections (1, 2) and/or in the reinforcement elements (3, 3′; 6, 6′; 23; 25; 21), to which the thermoplastic plastics material is anchored.

10. A composite structural part according to one of claims 1 to 9, characterised in that the thermoplastics material may consist of a non-reinforced or reinforced or filled plastics material, preferably based on polyamide (PA), polyester, in particular polyethylene terephthalate (PET), polybutylene terephthalate (PBT), polyolefin, in particular polypropylene (PP), polyethylene (PE), a styrene/acrylonitrile copolymer, in particular an acrylonitrile/styrene/butadiene copolymer (ABS), polycarbonate (PC), polypropylene oxide (PPO), (PSO), polyphenylene sulfide (PPS), polyimide (PI), (PEEK), polyketone, syndiotactic polystyrene (PS) or of any possible mixture of these plastics.

11. A composite structural part according to one of claims 1 to 10, characterised in that the reinforcement elements (21, 23, 25) are designed in one piece with at least one of the sections (1) or (2) and that sections (1) and (2) produce a form fit arrangement with each other.

12. Use of the composite structural part according to one of claims 1 to 11 as a structural element for machines, vehicles and structural parts of all types, in particular for motor vehicles, for electronic articles, for domestic appliances and for building materials.

13. Use of the composite structural part according to one of claims 1 to 11 as a structural part for motor vehicles, in particular doors, bumpers, brackets, front and rear parts of private cars, doorsill support frames, instrument panel supports, tailgate supports, roof frames and decorative elements.

14. A process for producing a composite structural part according to one of claims 1 to 11, characterised in that two or more sections (1, 2) are inserted or pushed into the reinforcement elements (3, 3′; 6, 6′; 23; 25; 21) or are surrounded by the reinforcement elements (3, 3′; 6, 6′; 23; 25; 21) with the formation of a temporary connection point (10) and that the connection point (10) is then entirely or partly injected with a thermoplastic plastics material in an injection moulding mould, wherein the sections (1, 2) are connected to the reinforcement elements (3, 3′; 6, 6′; 23; 25; 21).

15. A process for producing a composite structural part according to one of claims 1 to 11, characterised in that two or more sections (1, 2) are inserted or pushed into the reinforcement elements (3, 3′; 6, 6′; 23; 25; 21) or are surrounded by the reinforcement elements (3, 3′; 6, 6′; 23; 25; 21) with the formation of a temporary connection point (10) and that the connection point (10) is then entirely or partly surrounded with one or more moulded items (4, 5) made of a shrinkable thermoplastic plastics material and the sections (1, 2) are then connected to the reinforcement elements (3, 3′; 6, 6′; 23; 25; 21) by heat treatment of the moulded items (4, 5).

16. A process according to claim 14 or 15, characterised in that open sections (8, 9, 162, 242, 242′, 247, 222, 227) are used and reinforcement struts (41) are produced in the open sections (8, 9, 162, 242, 242′, 247, 222, 227) on injecting the thermoplastic plastics material.

17. A process according to claims 14 to 16, characterised in that additional reinforcement struts (41) are produced in the region of the connection point (10) on injecting the thermoplastic plastics material.

18. A process according to one of claims 14 to 17, characterised in that deformations (16, 26) are provided in the sections (1, 2) and/or the reinforcement elements (3, 3′; 6, 6′; 23; 25; 21), in particular indentations or bulges, and/or openings (34) or drilled holes at specific places in the sections (1, 2) and/or the reinforcement elements (3, 3′; 6, 6′; 23; 25; 21), before assembling or inserting, so that these overlap each other when assembling or inserting the sections (1, 2) and/or the reinforcement elements (3, 3′; 6, 6′; 23; 25; 21).
